(19) United States
(12) Patent Application Publication
(10) Pub. No.: US 2022/0266270 A1
(43) Pub. Date: Aug. 25, 2022

(54) LIQUID JETTING DEVICE FOR SKIN CLEANING

(71) Applicant: SEIKO EPSON CORPORATION, TOKYO (JP)

(72) Inventors: Takeshi SETO, Chofu-shi (JP); Hirokazu SEKINO, Chino-shi (JP); Yasunori ONISHI, Shiojiri-shi (JP)

(21) Appl. No.: 17/652,131

(22) Filed: Feb. 23, 2022

(30) Foreign Application Priority Data
Feb. 24, 2021 (JP) 2021-027322

(51) Int. Cl. B05B 1/18; B05B 1/10

(52) U.S. Cl. CPC B05B 1/18; B05B 1/10

(57) ABSTRACT

Provided is a liquid jetting device for skin cleaning configured to clean a skin using liquid droplets generated from a jetted continuous flow, wherein the liquid jetting device includes a jetting nozzle having a plurality of jetting nozzle holes. Further, an interval between each of the plurality of jetting nozzle holes is 1 mm or smaller, and a diameter of the jetting nozzle hole is in a range from 0.02 mm to 0.1 mm.

The present application is based on, and claims priority from JP Application Serial Number 2021-027322, filed Feb. 24, 2021, the disclosure of which is hereby incorporated by reference herein in its entirety.

### BACKGROUND

### 1. Technical Field

The present disclosure relates to a liquid jetting device for skin cleaning configured to perform skin cleaning by jetting a liquid toward a skin of a face and skins of other parts of a human body at a high pressure.

### 2. Related Art

JP-A-61-103443 discloses a skin cleaner as an example of this type of liquid jetting device for skin cleaning. JP-A-61-103443 discloses the skin cleaner that includes: a grip portion, a cup mounted on a distal end portion of the grip portion and having an opening thereof directed outward, and a jetting unit configured to atomize water that is pressure-fed from a discharge port of a pump into a mist form and to jet the water in a mist form toward the opening of the cup through the inside of the cup. The skin cleaner is used by bringing the jetting unit into contact with a skin.

However, in the skin cleaner disclosed in JP-A-61-103443, water is atomized into a mist form and, then, is jetted to a skin and hence, a sufficient pressing force cannot be applied to the skin thus giving rise to a drawback that it is difficult to effectively wash away sebum secreted from sebaceous glands existing at a depth of approximately 1 mm from a surface of the skin, and dirt.

### SUMMARY

According to an aspect of the present disclosure, there is provided a liquid jetting device for skin cleaning configured to clean a skin using liquid droplets generated from a jetted continuous flow, wherein the liquid jetting device includes a jetting nozzle having a plurality of jetting nozzle holes, an interval between each of the plurality of jetting nozzle holes is 1 mm or smaller, and a diameter of the jetting nozzle hole is in a range from 0.02 mm to 0.1 mm.

### BRIEF DESCRIPTION OF THE DRAWINGS

FIG. 1 is a view illustrating an overall schematic configuration of a liquid jetting device for skin cleaning according to a first embodiment of the present disclosure.

FIG. 2 illustrates a schematic plan view A and a schematic cross-sectional view B of a jetting nozzle according to the first embodiment.

FIG. 3 is a schematic cross-sectional view for explaining the manner of operation of liquid droplets according to the first embodiment.

FIG. 4 is a schematic cross-sectional view for explaining the significance of setting a diameter according to the first embodiment to 0.1 mm.

FIG. 5 is a graph showing the relationship between a pressure ratio and an interval between the jetting nozzle holes on a condition that a value of a pressure when the interval between the jetting nozzle holes is set to 0.38 mm is assumed as 1.

FIG. 6 is a plan view of a jetting nozzle according to a second embodiment of the present disclosure.

FIG. 7 is a plan view of a jetting nozzle according to a third embodiment of the present disclosure.

### DESCRIPTION OF EXEMPLARY EMBODIMENTS

Hereinafter, the present disclosure is firstly schematically described.

According to a first aspect of the present disclosure, there is provided a liquid jetting device for skin cleaning configured to clean a skin using liquid droplets generated from a jetted continuous flow, wherein the liquid jetting device includes a jetting nozzle having a plurality of jetting nozzle holes, an interval between each of the plurality of jetting nozzle holes is 1 mm or smaller, and a diameter of the jetting nozzle hole is in a range from 0.02 mm to 0.1 mm.

Here, in this specification, “the plurality of jetting nozzle holes are arranged at an interval of not more than 1 mm” is used in a context that the jetting nozzle may have portions where some of the jetting nozzle holes are disposed at an interval of not less than 1 mm as an interval between the jetting nozzle holes disposed adjacent to each other, within the scope in which advantageous effects of the present disclosure described later can be obtained.

The number of sebaceous glands on the face surface is estimated to be approximately 800 per square centimeter. Assuming that the sebaceous gland exists at each apex of tessellated equilateral triangles, a pitch of the sebaceous glands becomes 0.38 mm.

According to the first aspect, the interval between the plurality of jetting nozzle holes is 1 mm or smaller. Accordingly, a liquid droplet formed by being jetted from each of the jetting nozzle holes can be applied to areas of the skin close to the sebaceous glands one after another in an extremely short period as viewed in plan view of the surface of the skin. Further, by applying the liquid droplets to each of a plurality of portions around a position of the sebaceous gland as viewed in plan view one after another in an extremely short period, it is possible to exert a push-out force for pushing out sebum on each of the plurality of portions. With such a configuration, the sebum and the dirt are easily pushed out from pores due to the action of the push-out force.

Further, it has been known that a size of the liquid droplet becomes 1.88 times as large as the diameter. The diameter of the jetting nozzle hole is in a range from 0.02 mm to 0.1 mm and hence, when the size of the diameter is taken into account, the size of the liquid droplet is in a range from 0.038 mm to 0.188 mm. Further, when it is taken into account that the liquid droplet size fluctuates somewhat due to the flow of the liquid in the nozzle, a state of the flow of outside air, or the like, the liquid droplet size is in a range from approximately 0.02 mm to 0.2 mm as an average liquid droplet diameter.

According to the first aspect, liquid droplets of this size are applied to the skin one after another in an extremely short period and hence, it is possible to exert, on the skin, a push-out force of a magnitude effective for pushing out sebum and dirt. Accordingly, it is possible to effectively clean the skin by crushing sebum and the like pushed out from the sebaceous glands while pushing out sebum and dirt secreted from the sebaceous glands existing at a depth of approximately 1 mm from the surface of the skin, from pores.

A liquid jetting device for skin cleaning according to a second aspect of the present disclosure is characterized in that, in the first aspect, a velocity of the liquid droplet is in a range from 20 m/s to 60 m/s.

According to the second aspect, the velocity of the liquid droplet is in a range from 20 m/s to 60 m/s and hence, the cleaning in which sebum and dirt that are secreted from the sebaceous glands are pushed out from pores, the sebum and the like that are pushed out are crushed can be further effectively realized.

A liquid jetting device for skin cleaning according to a third aspect of the present disclosure is characterized in that, in the first aspect, a jetting velocity of a liquid jetted from the jetting nozzle hole is in a range from 20 m/s to 60 m/s.

The velocity of the liquid droplets is substantially equal to the jetting velocity of a liquid jetted from the jetting nozzle holes and hence, the velocity of the liquid droplets formed by being jetted when the liquid jetting velocity is in a range from 20 m/s to 60 m/s is in a range from 20 m/s to 60 m/s. According to the third aspect, advantageous effects substantially equal to the advantageous effects obtained by the second aspect can be obtained.

A liquid jetting device for skin cleaning according to a fourth aspect of the present disclosure is characterized in that, in any one of the first aspect to the third aspect, an interval between each of the plurality of jetting nozzle holes is in a range from 0.2 mm to 0.6 mm.

According to the fourth aspect, the interval between the plurality of jetting nozzle holes is in a range from 0.2 mm to 0.6 mm and hence, a liquid droplet formed by being jetted from each of the jetting nozzle holes can be applied to areas of the skin closer to the sebaceous glands as viewed in plan view of the surface of the skin. Accordingly, it is possible to further effectively exert the push-out force for pushing out the sebum and the dirt so that the sebum and the dirt can be further easily pushed out from the pores.

A liquid jetting device for skin cleaning according to a fifth aspect of the present disclosure is characterized in that, in any of the first aspect to the fourth aspect, the interval between the jetting nozzle holes farthest from each other is in a range from 3 mm to 10 mm.

According to the fifth aspect, the interval between the jetting nozzle holes farthest from each other is set to not less than3 mm. Accordingly, there is no possibility that a size of the jetting nozzle becomes excessively small so that it is possible to efficiently perform the cleaning of the skin. Further, the interval between the jetting nozzle holes farthest from each other is set to not more than 10 mm. Accordingly, it becomes easy to apply the liquid droplets also to recesses of the face such as nose wings, for example.

A liquid jetting device for skin cleaning according to a sixth aspect of the present disclosure is characterized in that, in any one of the first aspect to the fifth aspect, the jetting nozzle has four to thirty-one jetting nozzle holes, and the nozzles holes are arranged in a plurality of rows.

According to the sixth aspect, the jetting nozzle has four to thirty-one jetting nozzle holes, and the jetting nozzle holes are arranged in a plurality of rows. Accordingly, it is possible to efficiently perform the cleaning of the skin.

### First Embodiment

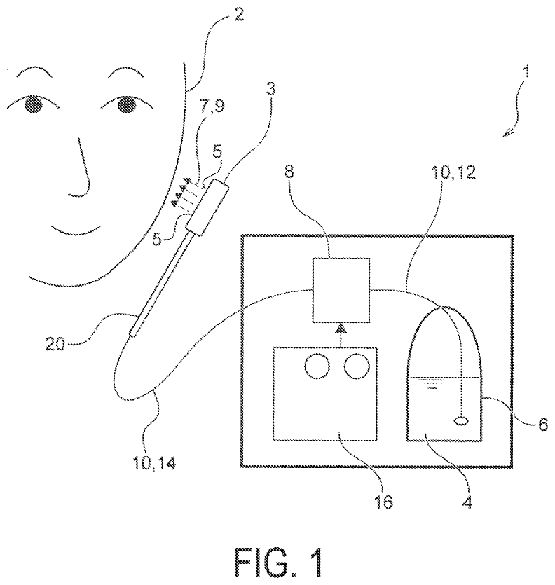

Hereinafter, the liquid jetting device for skin cleaning according to a first embodiment of the present disclosure is described in detail with reference to FIG. 1 to FIG. 5. In this embodiment, the liquid jetting device 1 for skin cleaning is described as a liquid jetting device for cleaning facial skin.

Here, it is needless to say that the liquid jetting device 1 for skin cleaning is not limited to a device for cleaning a skin of a face, and is also applicable to cleaning of the skins of arms, hands, legs, a back, and the like.

As illustrated in FIG. 1, the liquid jetting device 1 for skin cleaning according to the present embodiment is configured to clean the skin 2, such as facial skin, using liquid droplets 9 generated from continuous flows 7 jetted from jetting nozzle holes 5 of a jetting nozzle 3.

Specifically, the liquid jetting device 1 for skin cleaning according to the present embodiment includes: the jetting nozzle 3 configured to jet a liquid 4, a liquid tank 6 configured to store the liquid 4 to be jetted, a pump unit 8 that is a pressurizing unit, a liquid suction tube 12 that is configured to couple the liquid tank 6 and the pump unit 8 to each other thus forming a liquid flow path 10, and a liquid feed tube 14 that is configured to couple the pump unit 8 and the jetting nozzle 3 to each other thus also forming the liquid flow path 10.

In the pump unit 8, a pump operation is controlled by a control unit 16. That is, the control unit 16 adjusts a pressure of the liquid 4 fed to the jetting nozzle 3 through the liquid feed tube 14, or the like.

Jetting Nozzle

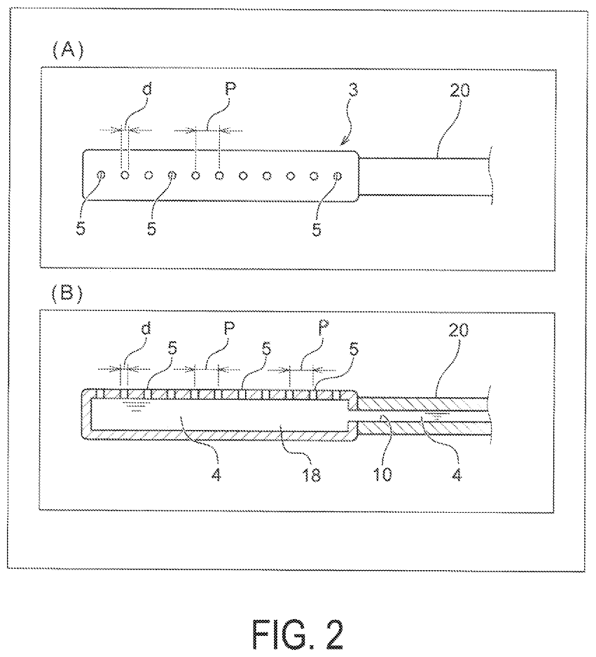

As illustrated in FIG. 2, the jetting nozzle 3 has a plurality of jetting nozzle holes 5 communicating with a liquid chamber 18 formed inside the jetting nozzle 3. The jetting nozzle 3 is attached to a distal end portion of a grip portion 20 that is gripped by a user's hand. The grip portion 20 has a proximal end portion thereof coupled to the liquid feed tube 14, and has a flow path 10 therein. An interval P (hereinafter also referred to as a “nozzle pitch P”) between the plurality of jetting nozzle holes 5 is 1 mm or smaller, and a diameter d of each jetting nozzle hole 5 is in a range from 0.02 mm to 0.1 mm.

Specifically, in the liquid jetting device 1 for skin cleaning according to the present embodiment, the number of the plurality of jetting nozzle holes 5 is set to eleven, and the eleven jetting nozzle holes 5 are formed so as to be arranged in a single row at equal intervals. Further, the nozzle pitch P is set to 0.5 mm, and the diameter d is set to 0.05 mm.

Here, the nozzle pitch P may not be limited to such a nozzle pitch, that is, the jetting nozzle holes 5 may not be arranged at equal intervals unlike the arrangement illustrated in FIG. 2. Further, some or all of the jetting nozzle holes 5 may be formed so as to be arranged at different nozzle pitches P. Further, all of the jetting nozzle holes 5 may not have the same diameter d, some or all of the jetting nozzle holes 5 may be formed to have different diameters.

Nozzle Pitch

It is considered that the number of sebaceous glands on the surface of the facial skin is 800 per 1 cm². Assume that 800 pores are distributed at equal intervals per 1 cm², and the pores are arranged at apexes of tessellated equilateral triangles, an average of the inter-pore distance becomes 0.38 mm, that is, approximately 0.4 mm.

Accordingly, by setting the nozzle pitch P to a distance not more than 1 mm that is close to the inter-pore distance of 0.4 mm, it is possible to exert a pressure for pushing out dirt such as sebum from the pores, that is, a push-out force on areas of the skin close to the sebaceous glands.

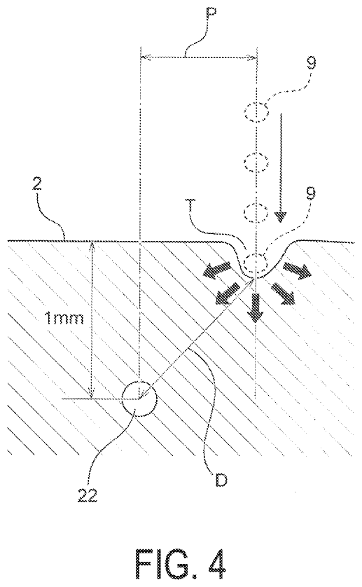

Specifically, as illustrated in FIG. 4, assuming the nozzle pitch as P, and assuming a depth of the sebaceous gland as 1 mm, a distance D (mm) of the sebaceous gland 22 from a landing point T of the liquid droplet 9 is expressed as an equation D²=1²+P². The distance D is a value acquired by taking the square root of the above-described equation.

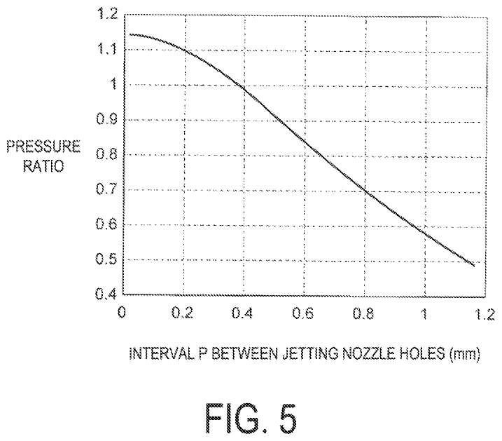

On the other hand, FIG. 5 is a graph showing the relationship between a pressure generated by landing of the droplet 9 and the nozzle pitch P within a range of from 0 mm to 1.2 mm. In the graph of FIG. 5, assume a value of a pressure when the nozzle pitch P is set to 0.38 mm as 1, and a pressure ratio relative to the value is taken on an axis of ordinates.

Assuming that a pressure propagated from the landing point T of the droplet 9 propagates uniformly in a semi spherical manner, a pressure due to landing is inversely proportional to a surface area of the droplet 9. As can be understood from FIG. 5, when the nozzle pitch P exceeds 1 mm, a pressure at that time becomes approximately one-half of a pressure when the nozzle pitch P is 0.38 mm, and the sebum push-out effect is reduced. That is, it can be said that when the nozzle pitch P is 1 mm or smaller, it is possible to exert a push-out force exhibiting an effective push-out effect on the sebum.

Further, as can be understood from FIG. 5, it can be said that by setting the nozzle pitch P to a value within a range of from 0.2 mm to 0.6 mm, the nozzle pitch P further approaches the inter-pore distance of 0.4 mm and hence, it is possible to further effectively exert the push-out force on the sebum.

The reason why the nozzle pitch P is preferably set to not less than 0.2 mm is described as follows. When the nozzle pitch P is set to not more than 0.2 mm, there is a concern that the jet flows formed by jetting a liquid from the jetting nozzle holes 5 disposed adjacent to each other, that is, the liquid droplets 9 interfere with each other so that the linearity of the liquid droplets 9 is disturbed. Accordingly, it is preferable that the nozzle pitch P be set to not less than 0.2 mm in order to reduce the influence of the interference thus maintaining the linearity of the liquid droplets 9.

Diameter

In the present embodiment, as described above, the diameter d of the jetting nozzle hole 5 is in a range from 0.02 mm to 0.1 mm.

Although the descriptions may be made in a partially repeated manner, it has been known that a size of the liquid droplet becomes 1.88 times as large as a diameter d of the nozzle hole from the inviscid linear theory. The diameter d of the jetting nozzle hole 5 is in a range from 0.02 mm to 0.1 mm and hence, when the size of the diameter d is taken into account, the size of the liquid droplet is in a range from 0.038 mm to 0.188 mm. Further, by taking into account that the size of the liquid droplet varies somewhat depending on the smoothness and the like of the jetting nozzle hole 5, the liquid droplet size is in a range from approximately 0.02 mm to 0.2 mm as the average liquid droplet diameter.

Here, most of the plurality of liquid droplets 9 actually have not a perfectly spherical shape but are deformed into an elliptical shape or the like and hence, the “average liquid droplet diameter” is obtained as an average value based on a longest diameter portion and a shortest diameter portion of each liquid droplet 9.

The liquid droplet having such a size is effective for skin cleaning and hence, the diameter d of the jetting nozzle hole 5 is in a range from 0.02 mm to 0.1 mm.

The control unit 16 controls the pump unit 8 so as to elevate the liquid 4 to a high pressure thus feeding the high-pressure liquid 4 to the liquid chamber 18. Accordingly, the continuous flow 7 is jetted from each of the injection nozzle holes 5 of the injection nozzle portion 3, and the continuous flow 7 is immediately formed into droplets so that the liquid droplets 9 are formed. A distance required for the continuous flow 7 jetted from the jetting nozzle hole 5 to be changed into the liquid droplets 9 is referred to as a liquid droplet forming distance. In the liquid jetting device 1 for skin cleaning, the liquid droplet forming distance is preferably set to not more than 10 mm.

The control unit 16 is configured to set a liquid feeding pressure of the pump unit 8, that is, a liquid feeding pressure at which the pump unit 8 feeds the liquid 4 to the liquid chamber 18 such that the liquid droplet forming distance becomes not more than 10 mm. In the present embodiment, it was confirmed that the liquid droplet forming distance becomes not more than approximately 10 mm when the liquid feeding pressure is in a range from 0.1 MPa to 1.5 MPa. Further, it was confirmed that when the liquid feeding pressure is set to a value within the above-described range, the jetted continuous flow jetted from the jetting nozzle hole 5 is in a range from 20 m/s to 60 m/s. Accordingly, in the present embodiment, the jetted continuous flow jetted from the jetting nozzle hole 5 is in a range from 20 m/s to 60 m/s.

The velocity of the liquid droplets 9 formed by being jetted from the jetting nozzle holes 5 is determined by the liquid jetting velocity. The liquid jetting velocity is in a range from 20 m/s to 60 m/s. Accordingly, the velocity of the liquid droplets 9 that are formed from the continuous flow 7 jetted from each of the jetting nozzle holes 5 is in a range from 20 m/s to 60 m/s.

Description on how liquid droplets crush sebum or the like while pushing out sebum or the like from pores.

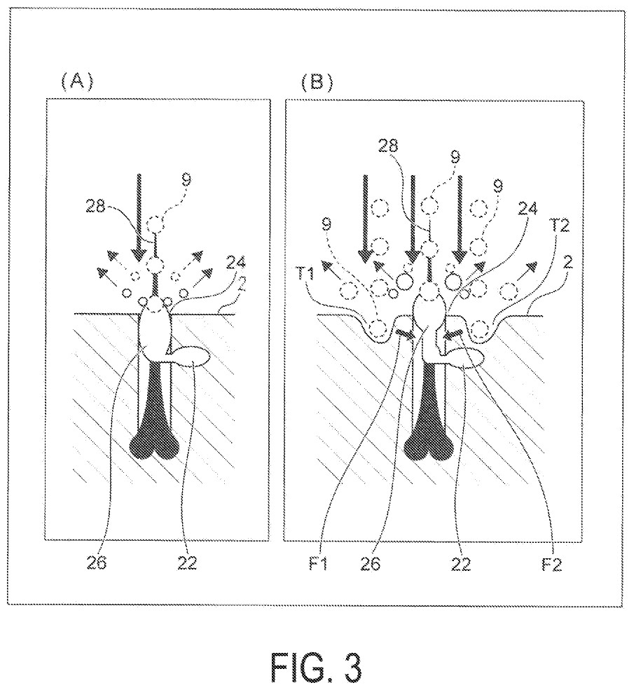

An illustration A in FIG. 3 shows a state in which the liquid droplets 9 are applied to a sebum 26 that is secreted from a sebaceous gland 22 existing in the depth of approximately 1 mm of the skin and is exposed on an infundibulum portion of a pore 24 of the skin 2. Symbol 28 indicates hair. As can be understood from the illustration A, with respect to a lump of the sebum 26, a portion of the lamp positioned on a surface of the skin 2 is crushed by the liquid droplet 9 and the crushed sebum are scattered. However, the sebum 26 positioned at a deep portion of the pore 24 is less likely to be crushed by the droplet 9.

An illustration B in FIG. 3 shows a state in which cleaning is performed by the liquid droplets 9, 9, . . . that are formed by being jetted from the respective jetting nozzle holes 5, 5, . . . of the jetting nozzle 3 illustrated in FIG. 2 according to the present embodiment. The nozzle pitch P is set to 0.5 mm that is not more than 1.0 mm. Accordingly, in addition to the droplet 9 directly applied to the position of the pore 24, the liquid droplets 9, 9, formed by being jetted from the jetting nozzle holes 5, 5 disposed on both sides of the jetting nozzle hole 5 from which the liquid droplet 9 directly applied to the position of the pore 24 is jetted, land at positions near the periphery of the pore 24 respectively. In the illustration B, symbols T1, T2 respectively indicate landing points of the liquid droplets 9, 9.

The liquid droplets 9, 9 applied to the landing points T1, T2 exert push-out forces F1, F2 on the sebum 26 positioned at the deep portion of the pore 24. Due to an action of the push-out forces F1, F2, the sebum 26 positioned at the deep portion of the pore 24 is pushed out toward the infundibulum portion of the pore 24 little by little. The pushed-out sebum 26 is crushed by applying the liquid droplet 9 directly applied to the position of the pore 24.

The sebum 26 at the infundibulum portion of the pore 24 is eliminated by such crushing and hence, the sebum 26 positioned at the deep portion of the pore 24 is easily pushed out and then pushed out one after another.

That is, the sebum 26 secreted from the sebaceous gland 22 existing at a depth of approximately 1 mm from the surface of the skin 2 and the dirt are crushed while being pushed out from the pore 24 by the liquid droplets 9.

Description on Manner of Operation of First Embodiment

Next, the description is made with respect to a case in which the skin 2 of the face is cleaned by the liquid jetting device 1 for skin cleaning according to the first embodiment.

A user grips the grip portion 20 and brings the jetting nozzle holes 5 of the jetting nozzle 3 close to the skin 2 of his/her face. Then, the user feeds a control signal to the pump unit 8 via the control unit 16 thus driving the pump unit 8. With such an operation, the liquid 4 in the liquid tank 6 is fed to the liquid chamber 18 (illustration B in FIG. 2) through the flow path 10 in a pressurized state. As a result, the liquid 4 in the liquid chamber 18 is jetted from the plurality of jetting nozzle holes 5, 5, . . . of the jetting nozzle 3 toward the skin 2 in the form of jetting fluid where a liquid droplet forming distance is not more than 10 mm.

With respect to the jetting fluid, an initial continuous flow 7 is divided by a surface tension so that a row of the liquid droplets 9 is formed. In such a state, the liquid droplets 9 are applied to the skin 2, and the sebum 26 and the like are crushed by the liquid droplets 9 so that the skin is cleaned. In the present embodiment, it was confirmed that the liquid droplets 9 generated from one jetting nozzle hole 5 are applied to the skin 2 one after another in a period of not more than 100 μs per second.

Description on Advantageous Effects of First Embodiment

(1) According to the present embodiment, the nozzle pitch P that is the interval between the plurality of jetting nozzle holes 5 is to not more than 1 mm. Accordingly, as shown in the illustration B of FIG. 3, the liquid droplets 9, 9, . . . formed by being jetted from each of the jetting nozzle holes 5, 5, . . . can be applied to areas of the skin close to the sebaceous gland 22 one after another in an extremely short period, specifically, in a period of not more than 100 μs, as viewed in plan view of the surface of the skin 2. Further, by applying the liquid droplets 9, 9, . . . to each of the plurality of portions around the position of the sebaceous gland 22 one after another in an extremely short period as viewed in plan view, it is possible to exert the push-out forces F1, F2, . . . on each of the plurality of portions. With such a configuration, the sebum 26 and the dirt can be easily pushed out from the pore 24 due to the action of the push-out forces F1, F2, . . . .

Further, the diameter d of the plurality of jetting nozzle holes 5, 5, . . . is in a range from 0.02 mm to 0.1 mm and hence, the size of the plurality of liquid droplets 9, 9, . . . is in a range from approximately 0.02 mm to approximately 0.2 mm as the average liquid droplet diameter, as described above. According to the present embodiment, the liquid droplets 9 of this size are applied to the skin 2 one after another in an extremely short period and hence, it is possible to exert the push-out forces F1, F2 of a magnitude effective for pushing out sebum and dirt, on the skin 2. Accordingly, it is possible to effectively clean the skin 2 by crushing the sebum 26 and the like pushed out from the sebaceous glands 22 while pushing out the sebum 26 secreted from the sebaceous glands 22 existing at a depth of approximately 1 mm from the surface of the skin 2 and the dirt, from pores 24.

(2) Further, according to the present embodiment, the interval between the plurality of jetting nozzle holes 5, 5, . . . is in a range from 0.2 mm to 0.6 mm and hence, the respective liquid droplets 9, 9, . . . jetted from each of the jetting nozzle holes 5, 5, . . . can be applied to areas of the skin closer to the sebaceous glands 22 as viewed in plan view of the surface of the skin 2. Accordingly, it is possible to further effectively exert the push-out forces F1, F2 on the sebum 26 and the dirt so that the sebum 26 and the dirt can be further easily pushed out from the pores 24.

(3) Further, according to the present embodiment, the velocity of the liquid droplets 9 is in a range from 20 m/s to 60 m/s and hence, the cleaning in which while the sebum 26 and the dirt secreted from the sebaceous glands 22 are pushed out from the pores 24, the pushed out sebum 26 and the like are crushed can be further effectively realized.

(4) Further, according to the present embodiment, the velocity of the droplets 9 is substantially equal to the injection velocity of the liquid jetted from the jetting nozzle holes 5 and hence, the velocity of the droplets 9 formed when the liquid jetting velocity is in a range from 20 m/s to 60 m/s is in a range from 20 m/s to 60 m/s. Accordingly, advantageous effects substantially equal to the advantageous effects (3) described above can be obtained.

(5) Further, in the present embodiment, the plurality of jetting nozzle holes 5, 5, . . . are arranged in a single row and hence, a user can move the nozzle portion 3 in a direction intersecting with a direction of the single row in a state where the user grips the grip portion 20, that is, the user can use the liquid jetting device like a brush and hence, usability of the liquid jetting device can be enhanced.

### Second Embodiment

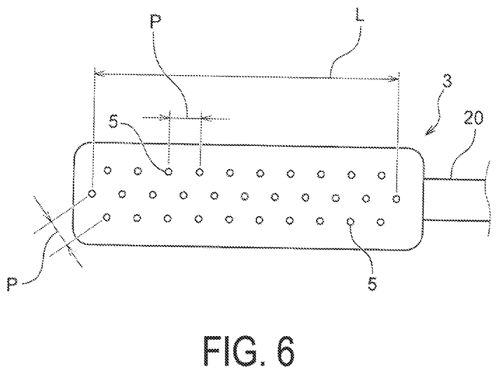

Next, a liquid jetting device 1 for skin cleaning according to a second embodiment of the present disclosure is described with reference to FIG. 6.

In the liquid jetting device 1 for skin cleaning according to the present embodiment, the interval L between the jetting nozzle holes 5, 5 farthest from each other is in a range from 3 mm to 10 mm. Further, with respect to the plurality of jetting nozzle holes 5, 5, . . . , unlike the firs embodiment in which the plurality of jetting nozzle holes 5 are arranged in a single row (illustration A in FIG. 2), thirty-one jetting nozzle holes 5 are arranged in a plurality of rows, that is, three rows. In this embodiment as well, all of the jetting nozzle holes 5 are arranged at the same nozzle pitch P, and are also formed to have the same diameter d. However, as described in the first embodiment, with respect to some or all of the jetting nozzle holes 5, the nozzle pitch P may differ within a range of not more than 1 mm, and the diameter d may differ within a range of from 0.02 mm to 0.1 mm.

Further, some of the jetting nozzle holes 5 may be disposed at a nozzle pitch P of not less than 1 mm as an interval between the jetting nozzle holes 5 disposed adjacent to each other, within the scope in which advantageous effects of the present disclosure can be obtained.

The other configurations are substantially equal to the corresponding configurations of the first embodiment and hence, identical parts are given the same symbols, and their repeated description is omitted. Further, the description with respect to substantially the same manner of operation and advantageous effects as those of the first embodiment is also omitted.

Description on Advantageous Effects 0f Second Embodiment

According to the present embodiment, the interval L between the jetting nozzle holes 5, 5 farthest from each other is set to not less than 3 mm. Accordingly, there is no possibility that a size of the jetting nozzle 3 becomes excessively small so that it is possible to efficiently perform the cleaning of the skin 2. Further, the interval L between the jetting nozzle holes 5, 5 farthest from each other is set to not more than 10 mm. Accordingly, it becomes easy to apply the liquid droplets 9 also to recesses of the face such as nose wings, for example.

### Third Embodiment

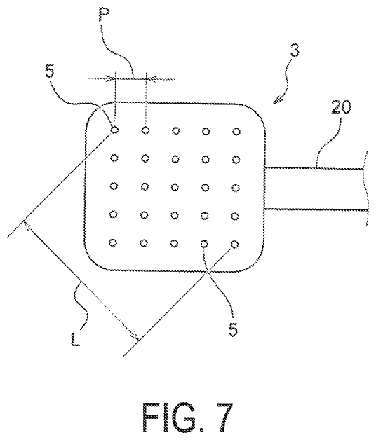

Next, a liquid jetting device 1 for skin cleaning according to a third embodiment of the present disclosure is described with reference to FIG. 7.

In the liquid jet device 1 for skin cleaning according to the present embodiment, the jetting nozzle 3 includes four to thirty-one jetting nozzle holes 5. Further, with respect to the plurality of jetting nozzle holes 5, 5, . . . , unlike the firs embodiment in which the plurality of jetting nozzle holes 5 are arranged in a single row (illustration A in FIG. 2), twenty five jetting nozzle holes 5 are arranged in a plurality of rows and columns, that is, five rows and five columns. The distance L between the jetting nozzle holes 5, 5 farthest from each other is smaller than that of the second embodiment. In this embodiment as well, all of the jetting nozzle holes 5 are arranged at the same nozzle pitch P, and are also formed to have the same diameter d. However, as described in the first embodiment, with respect to some or all of the jetting nozzle holes 5, the nozzle pitch P may differ within a range of not more than 1 mm, and the diameter d may differ within a range of from 0.02 mm to 0.1 mm.

Further, some of the jetting nozzle holes 5 may be disposed at a nozzle pitch P of not less than 1 mm as an interval between the jetting nozzle holes 5 disposed adjacent to each other, within the scope in which advantageous effects of the present disclosure can be obtained.

The other configurations are substantially equal to the corresponding configurations of the second embodiment and hence, identical parts are given the same symbols, and their repeated description is omitted. Further, the description with respect to substantially the same manner of operation and advantageous effects as those of the second embodiment is also omitted.

Description on Advantageous Effects of Third Embodiment

According to the present embodiment, four to thirty-one jetting nozzle holes 5 are arranged in a plurality of rows and columns and hence, a user can use the liquid jetting device 1 by moving the liquid jetting device 1 in a vertical direction and in a lateral direction, or by moving the liquid jetting device 1 so as to draw a circle in a state where the user grips the grip portion 20. Accordingly, usability of the liquid jetting device 1 can be enhanced so that it is possible to efficiently perform the cleaning of the skin 2.

### Other Embodiments

The liquid jetting device 1 for skin cleaning according to the embodiments of the present disclosure is based on the configuration described above. However, as a matter of course, modifications, omission, and the like may be made to a partial configuration without departing from the gist of the disclosure of the present application.

(1) In the description of the above-described embodiment, the control unit 16 is configured to set a liquid feeding pressure of the pump unit 8, that is, the liquid feeding pressure at which the pump unit 8 feeds the liquid 4 to the liquid chamber 18 such that the liquid droplet forming distance becomes not more than 10 mm. That is, the description has been made with respect to the structure in which the jetting pressure at which the jetting nozzle hole 5 jets the liquid is determined only by the liquid feeding pressure of the pump unit 8. Instead of this structure, the structure may be adopted in which a vibration plate and a piezoelectric element are provided in the liquid chamber 18, and the liquid droplet forming distance is changed by controlling a driving frequency of the piezoelectric element such that the driving frequency becomes not less than 100 kHz, for example.

What is claimed is:

1. A liquid jetting device for skin cleaning configured to clean a skin using liquid droplets generated from a jetted continuous flow, the liquid jetting device comprising a jetting nozzle having a plurality of jetting nozzle holes, wherein
an interval between each of the plurality of jetting nozzle holes is 1 mm or smaller, and
a diameter of the jetting nozzle hole is in a range from 0.02 mm to 0.1 mm.

2. The liquid jetting device for skin cleaning according to claim 1, wherein
a velocity of the liquid droplets is in a range from 20 m/s to 60 m/s.

3. The liquid jetting device for skin cleaning according to claim 1, wherein
a velocity of the jetted continuous flow jetted from the jetting nozzle hole is in a range from 20 m/s to 60 m/s.

4. The liquid jetting device for skin cleaning according to claim 1, wherein
the distance between each of the plurality of jetting nozzle holes is in a range from 0.2 mm to 0.6 mm.

5. The liquid jetting device for skin cleaning according to claim 1, wherein
the distance between jetting nozzles, among the jetting nozzle holes, farthest from each other is in a range from 3 mm to 10 mm.

6. The liquid jetting device for skin cleaning according to claim 2, wherein
the distance between jetting nozzles, among the jetting nozzle holes, farthest from each other is in a range from 3 mm to 10 mm.

7. The liquid jetting device for skin cleaning according to claim 3, wherein
the distance between jetting nozzles, among the jetting nozzle holes, farthest from each other is in a range from 3 mm to 10 mm.

8. The liquid jetting device for skin cleaning according to claim 4, wherein
the distance between jetting nozzles, among the jetting nozzle holes, farthest from each other is in a range from 3 mm to 10 mm.

9. The liquid jetting device for skin cleaning according to claim 1, wherein
the jetting nozzle has four to thirty-one jetting nozzle holes arranged in a plurality of rows.

10. The liquid jetting device for skin cleaning according to claim 2, wherein
the jetting nozzle has four to thirty-one jetting nozzle holes arranged in a plurality of rows.

11. The liquid jetting device for skin cleaning according to claim 3, wherein
the jetting nozzle has four to thirty-one jetting nozzle holes arranged in a plurality of rows.

12. The liquid jetting device for skin cleaning according to claim 4, wherein
the jetting nozzle has four to thirty-one jetting nozzle holes arranged in a plurality of rows.

13. The liquid jetting device for skin cleaning according to claim 5, wherein
the jetting nozzle has four to thirty-one jetting nozzle holes arranged in a plurality of rows.

14. The liquid jetting device for skin cleaning according to claim 6, wherein
the jetting nozzle has four to thirty-one jetting nozzle holes arranged in a plurality of rows.

15. The liquid jetting device for skin cleaning according to claim 7, wherein
the jetting nozzle has four to thirty-one jetting nozzle holes arranged in a plurality of rows.

16. The liquid jetting device for skin cleaning according to claim 8, wherein
the jetting nozzle has four to thirty-one jetting nozzle holes arranged in a plurality of rows.
